(19) United States
(12) Patent Application Publication
(10) Pub. No.: US 2025/0348299 A1
(43) Pub. Date: Nov. 13, 2025

(54) Incubation Hub for Validation and Deployment of Software on a Cloud Platform

(71) Applicant: Goldman Sachs & Co. LLC, New York, NY (US)

(72) Inventors: Jeremy Tyrrell, Southlake, TX (US); Balasubramanian Sakthivel, Plainsboro, NJ (US); David Wayne Dennis, II, Dallas, TX (US); Belinda Anne Neal, New York City, NY (US)

(21) Appl. No.: 19/201,844

(22) Filed: May 7, 2025

Related U.S. Application Data
(60) Provisional application No. 63/645,768, filed on May 10, 2024.

(51) Int. Cl. G06F 8/61; G06F 9/445; G06F 21/62

(52) U.S. Cl. CPC G06F 8/63; G06F 9/44505; G06F 21/6245

(57) ABSTRACT

A system performs incubation of software platform. The system software components for a software platform configured to run on a target cloud platform. The system selects a cloud platform account from an account pool. The system identifies a cloud provisioning template for running the software platform and extracts information describing deployment of the software platform based on the cloud provisioning template. The system configures the cloud platform account to run the software platform. The system bundles a set of software components including software artifacts, custom tools, and automated custom scripts used for running the software platform in a software repository. The system creates a software platform package based on the set of software components. The system provides the software platform package to a target cloud platform account for deployment and execution of the software platform for the tenant.

### CROSS REFERENCE TO RELATED APPLICATION

This application claims the benefit of U.S. Provisional Application No. 63/645,768, filed May 10, 2024, which is incorporated by reference in its entirety.

### BACKGROUND

### 1. Technical Field

The subject matter described relates generally to cloud computing and more specifically to validation and deployment of software via cloud platforms.

### INTRODUCTION

Organizations rely on cloud platforms for their infrastructure needs. Cloud platforms provide servers, storage, databases, networking, software, and so on over the internet to organizations. Organizations often acquire or develop software, for example, software tools for use in an organization. Certain organizations enforce specific processes due to regulatory guidelines. For example, certain industries follow specific regulatory requirements to store and process information. Development of software in such regulatory environments has significant overhead. For example, acquisition of each type of software requires following certain processes. Furthermore, specific controls may be enforced within the environment. As a result, developing software in such organizations has high overhead and may require consumption of additional computational and human resources.

### SUMMARY

A system performs incubation of software platform. The system receives from a code repository, software components for a software platform configured to run on a target cloud platform. The system selects a cloud platform account from an account pool. The account pool includes cloud platform accounts having access to cloud platform resources. The system identifies a cloud provisioning template for running the software platform. The system receives information describing deployment of the software platform based on the cloud provisioning template. The system configures the cloud platform account to run the software platform. The system may perform steps comprising, accessing a set of software artifacts, accessing one or more custom tools, running one or more automated custom scripts, and executing the software platform using the set of software artifacts, one or more custom tools, and one or more automated custom scripts. The system bundles the set of software artifacts, one or more custom tools, and one or more automated custom scripts used for running the software platform in a software repository. The system creates a software platform package based on the set of software artifacts, one or more custom tools, and one or more automated custom scripts used for running the software platform included in the software repository. The system provides the software platform package to a target cloud platform account associated with a tenant of the target cloud platform for deployment and execution of the software platform for the tenant.

According to an embodiment, the system identifies the software components for bundling by following dependencies across software components. The system identifies a particular software artifact and finds one or more other software artifacts on which the particular software artifact depends. The system includes the one or more other software artifacts in the set of software artifacts of the bundle.

Embodiments include non-transitory computer-readable storage media storing instructions that are executable by a one or more computer processors, the instructions causing the computer processors to perform steps of the methods disclosed herein. Embodiments include systems that comprise one or more computer processors and computer-readable storage media storing instructions that are executable by the one or more computer processors, the instructions causing the computer processors to perform steps of the methods disclosed herein.

### BRIEF DESCRIPTION OF THE DRAWINGS

FIG. 1 illustrates one embodiment of a networked computing environment 100 suitable for building software in a less regulated environment, according to an embodiment.

FIG. 2 illustrates the system architecture of an online system for running prototype builds on a cloud platform, according to an embodiment.

FIG. 3 illustrates the system architecture for provisioning on cloud platforms, according to an embodiment.

FIG. 4 is a flowchart illustrating the process for incubation of a software platform, according to an embodiment.

FIG. 5 illustrates the interaction between various cloud platform accounts performing a prototype build, according to an embodiment.

FIG. 6 illustrates the overall system environment in which an incubation hub operates according to an embodiment.

FIG. 7 shows a user interface for allowing a user to provide input describing the software platform, according to an embodiment.

FIG. 8 illustrates bundling of software components for the software platform to generate a software platform package.

FIG. 9 is a block diagram of an example computer suitable for use as a server or client device according to an embodiment.

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### DETAILED DESCRIPTION

Organizations often receive software from various vendors that supports specific features for potential acquisition. Such software is referred to herein as third-party software. The third-party software may be SaaS (software as a service) software or installable software. The third-party software may be an application, a system software, a software utility, a software tool (for example, a business intelligence tool for generating reports based on data), or any other type of software. A vendor that provides the third-party software also provides a description of the expected behavior of the software. Such description may identify specific features of the software and also describe details of each feature. Organizations evaluate such third-party software to ensure that the features identified and described in a specification or description of the software match the actual features that are observed by executing the software. Accordingly, the system of the organization compares the observed features of a software or a software system with a description or specification of the features to ensure that the software conforms to the expected behavior as described. For example, the organization needs to determine whether every feature of the third-party software performs as described or whether there are differences in the feature compared to the description, or whether one or more features are missing from the third-party software when compared with the expected behavior.

The system according to an embodiment acts as an environment for developing and testing software before deploying the software in a particular environment. For example, instead of developing and testing software or tools in a highly regulated environment that carries significant overhead, the system allows development of the software in a less regulated environment. The development process is referred to as a POC (proof of concept pilot programs for testing and validating vendor solution/software.) A POC may also be referred to herein as a software platform. The POC may be built on a cloud platform that is external to the organization and therefore acts as a less regulated environment compared to the environment of the organization. Such POCs require core infrastructure to be provisioned with necessary resources, maintained and monitored. As a result, the overhead of software development is significantly less since there are fewer controls that are enforced in a less regulated environment. Once the development process is completed, the system builds a software platform package based on the set of software artifacts used during the development process.

### System Environment

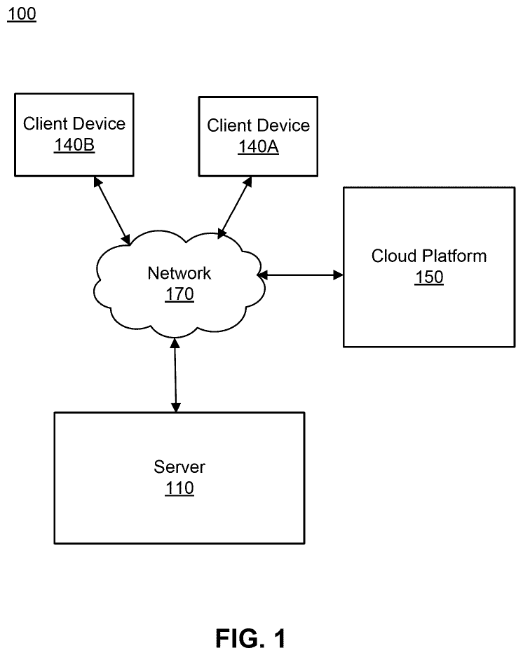

FIG. 1 illustrates one embodiment of a networked computing environment 100 suitable for building software in a less regulated environment, according to an embodiment. In the embodiment shown, the networked computing environment 100 includes a server 110, a cloud platform 150, and client devices 140, all connected via a network 170. The server 110 may also be referred to herein as an online system. In other embodiments, the networked computing environment 100 includes different and/or additional elements. In addition, the functions may be distributed among the elements in a different manner than described. Not only does this specific computer-implemented technique differ significantly from traditional human-centered approaches, but it also employs machine learning models to further improve order optimization in a manner inherent to computer technology.

The system environment shown in FIG. 1 according to an embodiment, uses automation and a DevOps-first strategy alongside tools and platforms such as cloud platform 150 (e.g., Amazon web services (AWS)), code repositories (e.g., GitLab), and a provisioning tool (e.g., Terraform). The system environment shown in FIG. 1 according to an embodiment automates the provisioning, maintenance, monitoring, and more of the core resources for these environments. The system is able to provision the core resources needed for accounts on the cloud platforms in minutes, allowing the developer assigned to the POC (proof of concept) to focus on infrastructure directly relating to the POC.

FIG. 1 uses like reference numerals to identify like elements. A letter after a reference numeral, such as “140A,” indicates that the text refers specifically to the element having that particular reference numeral. A reference numeral in the text without a following letter, such as “140,” refers to any or all of the elements in the figures bearing that reference numeral. For example, “140” in the text refers to reference numerals “140A,” “140B,” and/or “140N” in the figures.

The client devices 140 are computing devices with which users may interact with the server 110. Although two client devices are shown, client devices 140A and 140B the networked computing environment 100 may include any number of client devices 140, such as one client device 140. In one embodiment, the client device 140 presents a graphical user interface (GUI).

The cloud platform 150 may provide resource such as servers, storage, databases, networking, software, and so on to the client devices 140 or the server 110. Examples of cloud platforms 150 include AWS (AMAZON WEB SERVICES), GOOGLE cloud platform, MICROSOFT AZURE, and so on. Cloud platform 150 may provide computing resources on an on-demand basis via a public network such as internet. Cloud platform 150 allows enterprises to minimize upfront costs to set up computing infrastructure and also allow enterprises to get applications up and running faster with less maintenance overhead. Cloud platform 150 also allows adjusting computing resources to rapidly fluctuating and unpredictable demands. The server 110 communicates with the cloud platform 150 or client device 140 via network 170.

The network 170 provides communication channels via which the other elements of the networked computing environment 100 can communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

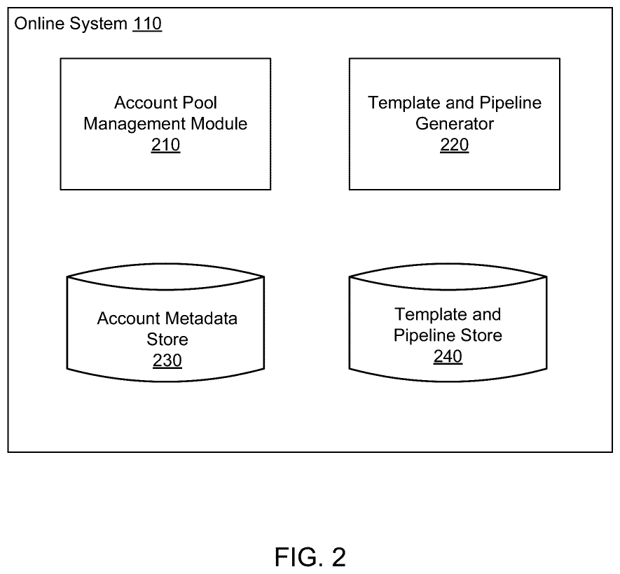

FIG. 2 illustrates the system architecture of an online system for running prototype builds on a cloud platform, according to an embodiment. The server 110 creates the infrastructure needed for running a prototype build. The server 110 includes an account pool management module 210, a template and pipeline generator 220, an account metadata store 230, and a template and pipeline store 240. Other embodiments may include more or fewer components than indicated herein.

The account pool management module 210 manages an account pool comprising a plurality of cloud platform accounts. According to an embodiment, certain cloud platform accounts of the account pool are configured with access to specific cloud platform resources, for example, databases, datawarehouses, and so on. The account metadata store 230 stores metadata describing the various cloud platform accounts of the account pools. The account metadata store 230 also stores status of each cloud platform account, for example, whether the cloud platform account is in use by a prototype build and the information describing the prototype build that is using the cloud platform account.

The template and pipeline store 240 stores a library of templates (or custom modules) and pipelines for various types of account configurations that can be used for prototype builds. According to an embodiment, the template and pipeline store 240 stores one or more bootstrap cloud provisioning templates that are common across a plurality of cloud platform resources and one or more application specific cloud provisioning templates generated for the prototype build. According to an embodiment, the execution at least one of the pipelines generated from a cloud platform template creates a source code repository on a source code management system. The source code repository comprises instructions for performing the prototype build.

As an example, if a user wants a prototype build with virtual machines, the user can select an appropriate template. According to an embodiment, the system uses a CI/CD platform such as Terraform™ or Spinnaker™. The templates may be CI/CD platform specific (e.g., Terraform templates). According to an embodiment, the template and pipeline generator 220 generates templates and pipelines specific to a prototype build. For example, the template and pipeline generator 220 receives information describing the requirements specific to a prototype build. The input may be provided by a user via a user interface. Alternatively, the template and pipeline generator 220 receives a description of the prototype build and analyzes the description to determine the requirements of the prototype build, for example, the cloud platform resources required for running the prototype build. For example, if the description of the prototype build specifies that machine learning based models are trained and executed as part of the prototype build, the template and pipeline generator 220 may identify the types of processors, for example, GPU (graphical processing units) having the computing resources for training and executing the machine learning based models and accordingly generates templates and pipelines for provisioning cloud platform accounts with the required computing resources. According to an embodiment, the template and pipeline generator 220 obtains the description of the prototype build from code commits of a code repository in which the software for the prototype build was stored and developed. The template and pipeline generator 220 uses machine learning based language models to analyze the description which may be in natural language text.

According to some embodiments, the system maintains a set of prototype build independent templates that are applicable to all prototype builds and a set of prototype build specific templates that are generated. For example, certain resources are used by each account and are provisioned using the prototype build independent template executed for each account. However, certain resources may be used for specific types of prototype builds. Accordingly, some templates provision specific sets of resources that are useful for specific categories of prototype builds. Given a prototype build, the system receives a set of input parameters describing the prototype build and identifies the needs of the prototype build. For example, an input parameter may indicate whether the prototype build needs GPU compute, another input parameter may specify whether the prototype build needs a datawarehouse, another input parameter may specify whether the prototype build needs a relational database, and so on. Based on the needs of the prototype build, the system determines the appropriate template(s) to use for the prototype build. The system identifies the templates and executes the pipelines corresponding to the templates to provision resources in preparation for the prototype build and deprovision resources when the prototype build is completed so that the accounts are cleaned up and returned to the account pool.

According to an embodiment, the system executes a job associated with a code repository (for example, a GitLab job) that runs a pipeline by selecting the pipeline and creating a Git repository. The variables in a template are instantiated based on input parameters specified by the user. The system may perform a build (e.g., a python build) to create the Git repository with the template. Multiple Git repositories may use a shared continuous integration (CI) file used for project configuration. This file may be a YAML file that defines the project's pipelines, jobs, and environments. The YAML file defines a set of jobs with constraints specifying when each job should be run.

The template allows the system to perform account provisioning for cloud platforms such as AWS using infrastructure as code to achieve control plane provisioning. By leveraging shared services, DevOps VPC (virtual private cloud), Cloud Trail Audits as well as private subnets/accounts for each prototype build, the system achieves the robustness of a production environment while still maintaining the speed and efficiency for rapidly testing prototypes. The system as discloses does not require any manual set up or process. The system tracks all the accounts used for each prototype build for auditing purposes. The system also tracks (logs) the cost of each account usage for a prototype build.

The system maintains an account pool. For a given prototype build, the system identifies one or more templates and uses these templates to select a set of accounts of different types and provisions appropriate resources (e.g., AWS components) for each account. Once the prototype build is completed, the system packages all the information needed for building and deploying the software platform. This may include various software artifacts, various scripts, configuration files, and so on. According to an embodiment, the system generates CI/CD (continuous integration/continuous deployment) pipelines (e.g., terraform pipelines) for collecting all the relevant software artifacts and scripts needed for building and/or setting up the software platform and collected them as a package. The system may transmit the package to a target system, for example, a cloud platform account for a target tenant of the cloud platform on which the software platform may be deployed. The account used for building the software platform may be a less regulated environment, thereby making the development process easier since various tools may be used with fewer controls. The target system may be a highly regulated environment on which the software platform is subsequently deployed. Developing the software platform on the less regulated environment carries less overhead and is more efficient. The developers can try different variations of software artifacts and tools in a less regulated environment before moving to the highly regulated environment. Once the software platform is moved to the target system that is highly regulated, the software platform conforms to all controls of the highly regulated environment. However, the entire development, testing, staging and other steps for building the software platform are performed in the less regulated environment.

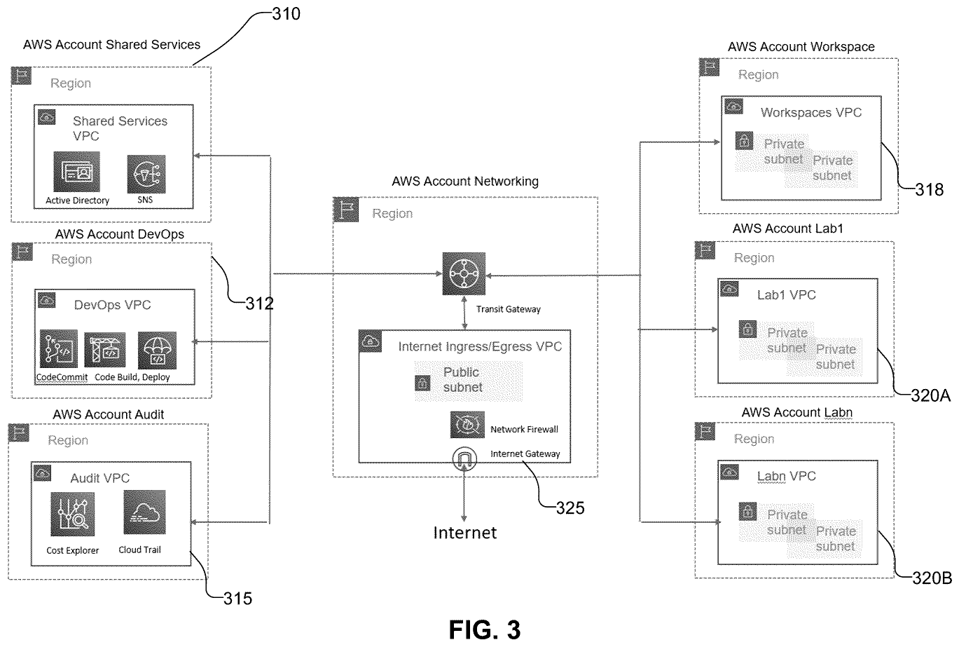

FIG. 3 illustrates the system architecture for provisioning on cloud platforms, according to an embodiment. The system maintains an account pool. For a given software platform, the system identifies one or more templates and uses these templates to select a set of accounts of different types and provisions appropriate resources (e.g., AWS components) for each account. Once the software platform is completes, the system cleans up (or deprovisions) the resources of each account used for the software platform and returns the accounts to the account pool. The system tracks all the accounts being used for a software platform so as to ensure that the same account is not used for multiple software platforms. According to an embodiment, the system generates CI/CD (continuous integration/continuous deployment) pipelines (e.g., terraform pipelines) for provisioning each account used for the software platform and also for deprovisioning each account once the software platform development is complete. A software platform may be associated with two or more accounts, for example, a dev account for development environment, and a prod account for production environment. The dev account allows developers/software engineers to make changes to the accounts, for example, while the software platform development is in progress. The prod account is for end users that run the software platform and may be used by multiple users running the software platform. The pipelines may be generated for each software platform. The CI/CD process may decide which environment to use based on the branch.

The shared services VPC represent services that can be used by various software platforms, for example datawarehouses, database schemas (e.g., using snowflake), and so on. The system maintains or more datawarehouses and database schemas that are preloaded with data. The DevOps account creates and maintains templates and corresponding pipelines. The AWS account Lab1, . . . , AWS account Labn represent the account pool.

The system uses various accounts including: network account 325 that provides access to network resources such as transit gateway and network firewall; DevOps account 312 with access to resources for creating and maintaining infrastructure as code (IAC), performing code commit, code deployment, and so on (access is limited to users responsible for creation of IAC scripts for each prototype build or POC); POC1 account 320A, . . . , POCn account 320B allows external users to set up specialized prototype build components; workspaces account 318 allows users to provision workspaces; shared services account 310 provides access to shared services. The shared services VPC represent services that can be used by various prototype builds, for example datawarehouses, database schemas (e.g., using snowflake), and so on. The system maintains or more datawarehouses and database schemas that are preloaded with data. There are other accounts such as master account (administrator account used for creating other accounts such as prototype build accounts), audit/security account 315, log/archive account, and so on.

The system according to an embodiment, creates the infrastructure needed for running a software platform. The system maintains a library of templates (or custom modules) for various types of account configurations that can be used for software platforms. For example, if a user wants a software platform with virtual machines, the user can select an appropriate template. According to an embodiment, the system uses a CI/CD platform such as Terraform or Spinnaker. The templates may be CI/CD platform specific (e.g., Terraform templates).

According to some embodiments, the system maintains a set of software platform independent templates that are applicable to all software platforms and a set of software platform specific templates that are generated. For example, certain resources are used by each account and are provisioned using the software platform independent template executed for each account. However, certain resources may be used for specific types of software platforms. Accordingly, some templates provision specific sets of resources that are useful for specific categories of software platforms. Given a software platform, the system receives a set of input parameters describing the software platform and identifies the needs of the software platform. For example, an input parameter may indicate whether the software platform needs GPU compute, another input parameter may specify whether the software platform needs a datawarehouse, another input parameter may specify whether the software platform needs a relational database, and so on. Based on the needs of the software platform, the system determines the appropriate template(s) to use for the software platform. The system identifies the templates and executes the pipelines corresponding to the templates to provision resources in preparation for the software platform and deprovision resources when the software platform is completed so that the accounts are cleaned up and returned to the account pool.

According to an embodiment, the system executes a job associated with a code repository (for example, a GitLab job) that runs a pipeline by selecting the pipeline and creating a Git repository. The variables in a template are instantiated based on input parameters specified by the user. The system may perform a build (e.g., a python build) to create the Git repository with the template. Multiple Git repositories may use a shared continuous integration (CI) file used for project configuration. This file may be a YAML file that defines the project's pipelines, jobs, and environments. The YAML file defines a set of jobs with constraints specifying when each job should be run.

The template allows the system to perform account provisioning for cloud platforms such as AWS using infrastructure as code to achieve control plane provisioning. By leveraging shared services, DevOps VPC (virtual private cloud), Cloud Trail Audits as well as private subnets/accounts for each software platform, the system achieves the robustness of a production environment while still maintaining the speed and efficiency for rapidly testing prototypes. The system as disclosed does not require any manual set up or process. The system tracks all the accounts used for each software platform for auditing purposes. The system also tracks (logs) the cost of each account usage for a software platform.

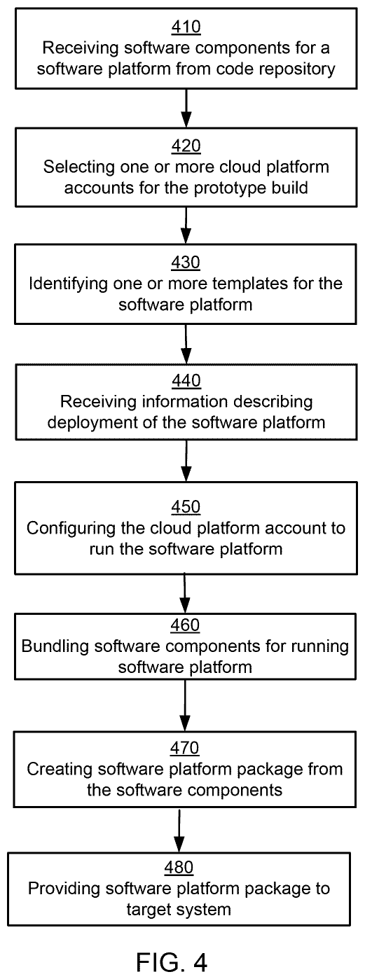

FIG. 4 is a flowchart illustrating the process for incubation of a software platform, according to an embodiment. The steps disclosed may be performed by various components of a system such as the system illustrated in FIG. 1. The steps may be performed in an order different from that indicated in FIG. 4. For example, certain steps may be performed in parallel.

The system receives 410 from a code repository, various software artifacts for building a POC or a software platform. The software platform being built is configured to run on a target cloud platform. The software artifacts may include source code, software libraries, scripts, and so on. The system selects 420 one or more cloud platform accounts from an account pool of cloud platform accounts having access to cloud platform resources.

The system identifies 430 one or more a cloud provisioning templates for running the software platform. According to an embodiment, the system presents a user interface that allows a user to provide information describing the details of the software platform. The system selects the templates based on the requirements of the software platform. For example, a particular type of software platform may require specific set of computing resources and therefore needs templates that provide those computing resources.

The system receives 440 information describing deployment of the software platform based on the cloud provisioning template. For example, the system may analyze the cloud provisioning template to determine the types of software components that may be needed for building the software platform and deploying the software platform. For example, based on the cloud provisioning template, the system may determine that components such as a database, a web server, and a particular runtime environment may be needed for the software platform.

The system configures 450 the cloud platform account to run the software platform. The system provisions resources for the components identified in step 440. The system may perform various steps including, accessing a set of software artifacts, accessing one or more custom tools, running one or more automated custom scripts, and executing the software platform using the set of software artifacts, one or more custom tools, and one or more automated custom scripts. Users, for example, developers and testers may build and test the software platform, for example, by modifying scripts, modifying source code, and performing various developer operations including compiling source code, debugging and testing source code. The users may follow specific procedures to determine that the software platform is ready, for example, if the software platform successfully executes a set of test cases.

The system bundles 460 various software components including the set of software artifacts or libraries, one or more custom tools, and one or more automated custom scripts used for running the software platform in a software repository. For example, the system may copy all the software components to a directory.

The system creates 470 a software platform package based on the set of software artifacts, one or more custom tools, and one or more automated custom scripts used for running the software platform included in the software repository. The software platform package may be a jar file, a software image, or any other group of software components that can be stored and transmitted.

The system provides 480 the software platform package to a target system, for example, a second cloud platform account associated with a tenant of the target cloud platform. The target system may deploy and execute the software platform for the tenant. The target system may be a highly regulated environment.

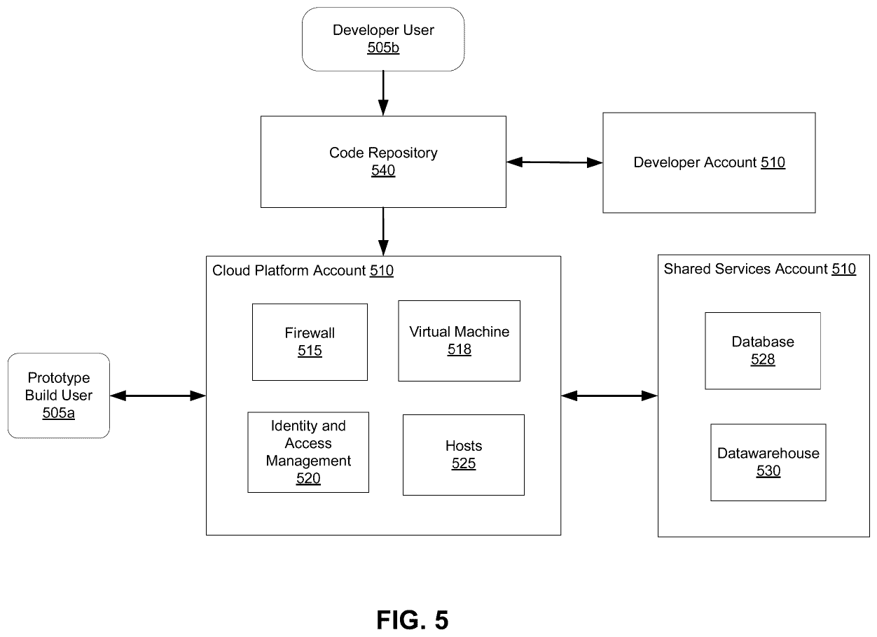

FIG. 5 illustrates the interaction between various cloud platform accounts performing a prototype build, according to an embodiment. Assigned engineers represent developer users 505b that make code changes/development of scripts for testing. A prototype build user 505a may be a non-developer who uses a prototype build and may do so using user friendly user interfaces.

According to an embodiment, the system maintains multiple pools, one pool for each account type, each account type having different access level to resources. For example, the system may maintain two different pools, a pool for engineer accounts and a pool for prototype build user accounts. Engineers may have developer access that allows them to update scripts whereas prototype build users have only access to execute the script or specific features without modifying them.

As every prototype build is different and may vary in requirements, the system maintains a pool of accounts in a centralized database, allowing the system to track accounts that are in use, and vice versa. This also allows the system to pool for accounts based on configuration, only pooling accounts for prototype build with the required services enabled that may not be enabled in the cloud platform (e.g., AWS) by default. For example, a Machine Learning based prototype build may require GPU (graphical processing unit) compute. For such a prototype build, the system polls an account that has those services pre-approved. The system may adjust the adjust the allocation (i.e., the ratio) of the different types of accounts in the account pool based on prototype build usage that is monitored on an ongoing basis. Accordingly, the account pool is dynamically adjusted based on changes in prototype build needs. Accordingly, the cloud platform accounts include one or more groups of cloud platform accounts, each group of cloud platform accounts comprising cloud platform accounts having equivalent set of cloud platform resources. The server 110 monitors cloud platform resources used by prototype builds performed over a time interval using the cloud platform and adjusts a number of cloud platform accounts in each group of cloud platform accounts based on results of monitoring.

The system maintains various shared services such as Redshift (datawarehouse 530), snowflake (relational database 528), lambda (serverless functions), and so on. Various services (e.g., Kubernetes) may be run within containers using engineer accounts so that prototype build users can access the services. Using the shared services and other services, the system is able to bring up any configuration needed for running a prototype build.

According to an embodiment, a code repository such as GIT is used to update the template with various values specific to a prototype build. The GIT commit triggers the execution of the required pipelines for provisioning the various accounts for a prototype build.

A code repository 540, for example, external GitLab is used for source code management, and out-of-the-box CI support for infrastructure deployments to cloud platform accounts. Centralized developer account 510 is used to manage terraform states, terraform locks, common lambda images, and GitLab runners. The cloud platform account onboarding, monitoring, and maintenance, for these cloud platform accounts, are fully automated, via a project creation CI process. System uses identity and access management 520, RBAC (role-based access control) and security constraints available leveraging network security using firewalls (e.g., Amazon WAF (web application firewall), hosts 525, virtual machines 518 (e.g., EC2 instances), AWS Managed AD (active directory), or user directory (e.g., Amazon Cognito). According to an embodiment, a pipeline also generates the rules for the WAF (web application firewall 515) specified to the prototype build. System provides CI (continuous integration) support for specific project development, leveraging cloud provisioning models (e.g., terraform models), or custom-built code, for a specific prototype build. System performs integration with shared services, allowing access to common data sets or APIs. System further performs integration with third-party vendors, via the public cloud.

### Incubation Hub

After validation of a software, the system allows packaging and deployment of the software for users or tenants of the cloud platform. The system includes an incubation hub that allows extraction of a package from the cloud platform account used for validation of a software. The package is built and further evaluated for any potential risks. The package is shipped to a target organization or a tenant of the cloud platform.

The techniques disclosed herein allow software platforms developed by a team that are configured to deploy on a cloud platform to be executed as a proof of concept and using the execution to identify a package that includes all relevant software artifacts, scripts, content, and so on that can be deployed on another cloud platform account. There may be custom software for example, scripts/code developed for running the POC. The custom software is also included in the package. For example, if the POC was prepared as a demonstration for a target organization, the POC can be deployed on a cloud platform account of the target organization (assuming the target organization is a tenant of the cloud platform). As a result, any effort spent in making a new software platform run on a cloud platform and the entire solution built for demonstrating the software platform for a customer can be packaged and reused when the software platform is shipped to the customer.

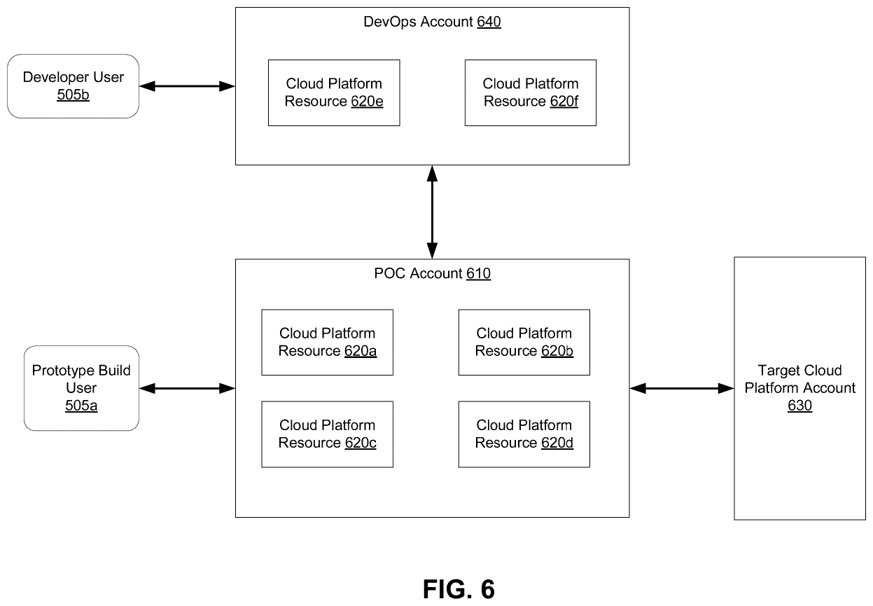

FIG. 6 illustrates the overall system environment in which an incubation hub operates according to an embodiment. Expert users such as developer users 505b and architects use a DevOps account 640 to review details of the system such as data, connectivity, architecture, and so on in preparation for a POC or the software platform. The DevOps account may include cloud platform resources 620e, 620f. The required resources needed for the software platform are reviewed and transferred to a POC account on the cloud platform. The POC account may include cloud platform resources 620a, 620b, 620c, 620d. A team member provisions the POC account 610. Alternatively, the POC account 610 is provisioned by an automated script. The POC account 610 may be selected from an account pool. Once the core deployment is complete, custom modules are built and deployed to support the software platform. The deployment is completed, and custom modules may be built and deployed to support the software platform. Once the software platform is approved and a target organization approves the software platform and sends a request to acquire the software, the software platform package is bundled including infrastructure as code (IaC) relevant to the deployment, software, images, and so on. The software platform package is provided to a target cloud platform account 630. The software platform package can be used by the target organization out of the box. The software platform package may be further reviewed for risks. The target organization may be a tenant of the cloud platform.

According to an embodiment, a software development team that is interested in demonstrating a software platform meets with other team and users relevant for evaluating the software platform. Any content and software artifacts needed to demonstrate the software platform is extracted and transferred to a cloud platform account. Users and scripts are used to provision the incubation hub mapping and to bootstrap the cloud platform account. Users such as developers of the platform build/push changes as needed from a software repository (such as GitHub) to support their platform and infrastructure. The software platform may be executed, for example, for testing or for demonstration as a POC. The above cycle may be repeated to incorporate any feedback based on the POC.

If the software platform is approved for purchase or for deployment for a target organization, following steps are executed. Users run tooling or scripts to bundle required software and IaC to extract the software as a platform and build a package. The package is prepared for deployment to any target cloud platform account. The package may be evaluated for risks and is delivered to any target organization (customer) that may be a tenant of the cloud platform.

According to an embodiment, a user, for example, a team member starts a process associated with a code repository such as GitLab. The process may be referred to as a bundling job, a bundling process, or a GitLab job. The process manages a package pipeline responsible for bundling artifacts and code, testing the bundle, and packaging the bundle.

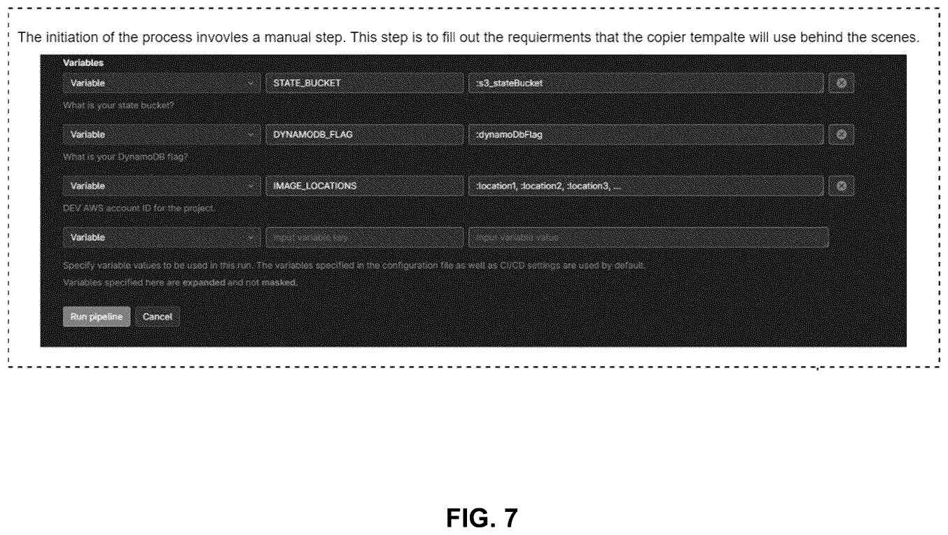

FIG. 7 shows a user interface for allowing a user to provide input describing the software platform, according to an embodiment. The user interface may request specific information the represent requirements of the software platform. The system uses the information received from the user to identify templates for use by the software platform.

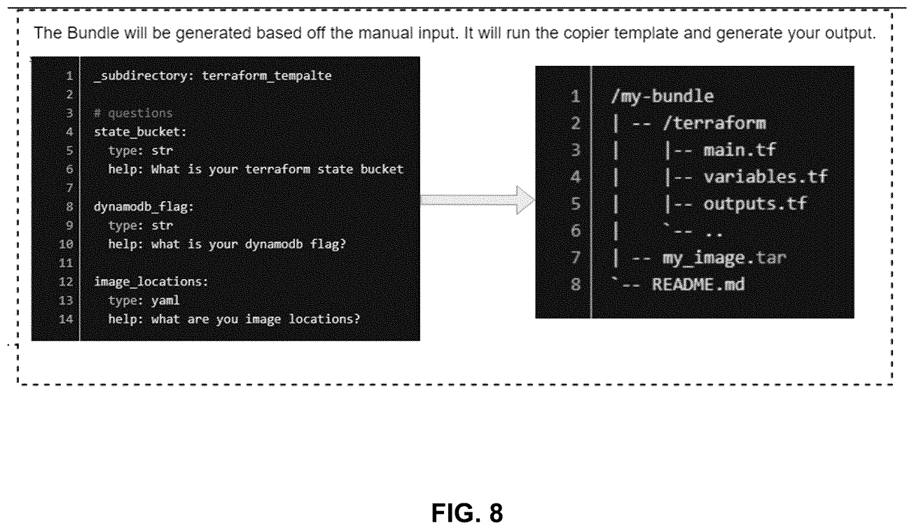

FIG. 8 illustrates bundling of software components for the software platform to generate a software platform package.

According to an embodiment, the bundling process takes the inputs to the GitLab job trigger and fills out a template that describes the environment used for running the software platform. The bundling process extracts the required components from a database storing software artifacts and bundles them into a project directory.

The bundling process is automated and ensures only the required, tested and production environment ready components that are needed are exported. The bundle is driven off deployment states from the applications production environment, which the system keeps isolated for each application, these states include infrastructure and other components such as networking, storage, share services, data, software, and application specific components, that when bundled provide an out of the box platform that an external party can take and deploy directly to their cloud provider environment, with all necessary infra, software and config required.

The bundling process is fully automated. A user starts the process by triggering the bundle workflow, with the inputs required to build the bundle from the deployed state. Based on these inputs the bundle can be built using the templating framework, which parses the state files to pick and choose which components are required.

The bundling process takes into consideration regulatory guidelines and requirements such as autodetecting data privacy classification, ip code scanning etc. For example, a DB tool built on this platform with large quantities of data would undergo a scanning for PI (Personally Identifiable) and would be flagged if there are PI information based on the tool data classification. If sensitive information is identified then the bundling process fails and would require the sensitive information to be removed. Another use case would be around building a platform in the incubation hub and moving it within the firm for internal firm usage which would not require such extensive scanning. The system keeps a copy of the bundle and the state file used for generating to answer any audit related queries.

The bundle is executed against an available cloud platform account to ensure no dependencies were missed and to make sure that the bundle can be deployed on a cloud platform. The bundle configures a pipeline for execution by a deployment engine (or an IaC tool), used by DevOps teams to automate various infrastructure tasks, for example, Terraform. The system prefills one or more inputs to the pipeline that an end user needs to fill out for custom configurations. The bundle is packaged, for example, as a zip file. The bundle may be exported to a code repository as a package, for example, to GitLab as a GitLab job artifact. The package may be compressed. The package may be further reviewed, for example, for risk evaluation. The package may be used to deploying the software platform out of the box in another cloud platform account, for example, for deploying for another tenant of the cloud platform that may represent a customer of the software platform.

The disclosed techniques allow a software platform to be tested and executed on a cloud platform by teams of users. For example, an organization O1 (for example, an enterprise or a company) may allow teams of another organization O2 to add custom code for running/testing software platform developed by organization O1 and then package all the custom code, libraries, other software artifacts used for the development for deploying on a cloud platform account of the organization O2. This allows organizations O2 that are customers of a particular organization O1 to test and try out a software platform of organization O1 and purchase it when they are satisfied with the software platform. The testing and POCs may be performed within a secure environment of the organization O1. Once the customer organization O2 is satisfied with the software platform, the organization O1 is able to use the system/processes disclosed herein to provide the environment developed/tested by the organization O2 to a cloud platform account of O2. This is an improvement over existing technologies that either require providing the software platform to environments that are not secure for organization O1, thereby exposing the software platforms of organization O1 to other organizations without any commitment to purchasing the software platforms. Alternatively, if the organization O1 allows the organization O2 to use secure environments of organization O1 for testing and performing POCs, current techniques require organization O2 to waste the effort and redo the effort when they acquire the software platform since all effort is left behind within the systems of organization O1. The disclosed techniques provide the secure environments of organization O1 to be used for POCs based on software platforms developed by the Organization O1, thereby maintaining security and avoiding exposure to external systems. However, any effort involved in developing a POC is not wasted and is utilized when the software platform is acquired/purchased by a customer organization O2. Accordingly, the disclosed techniques provide an improvement to security of existing systems and improve the technologies of deploying software platforms using cloud platforms. Furthermore, the techniques improve the resource utilization of computing resources by reusing the efforts in developing the POC for actual deployment of the software platform.

### Computing System Architecture

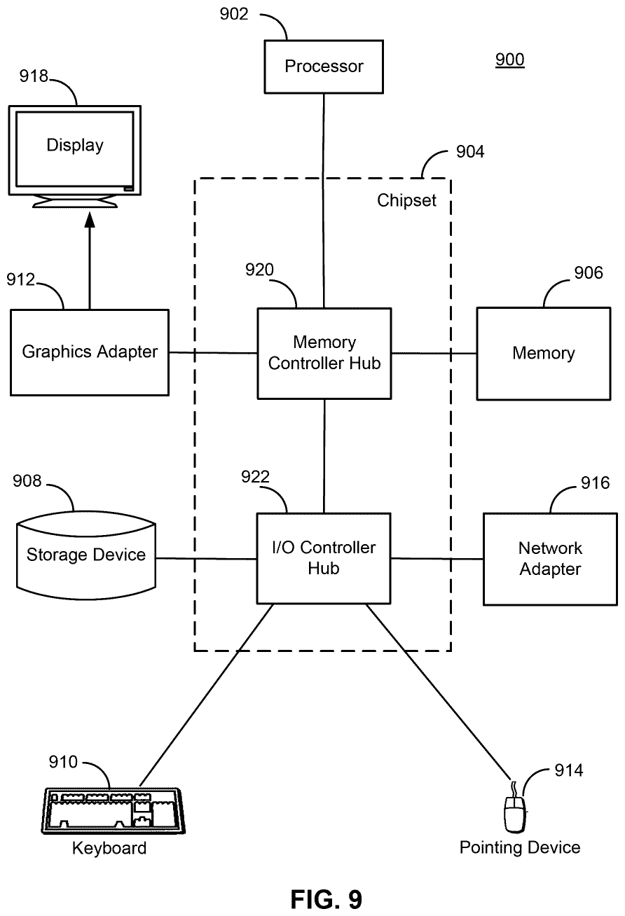

FIG. 9 is a block diagram of an example computer 900 suitable for use as a server 110 or client device 140. The example computer 900 includes at least one processor 902 coupled to a chipset 904. The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touch-screen, or other type of pointing device, and may be used in combination with the keyboard 910 (which may be an on-screen keyboard) to input data into the computer 900. The graphics adapter 912 displays images and other information on the display 918. The network adapter 916 couples the computer 900 to one or more computer networks, such as network 170.

The types of computers used by the entities of FIGS. 1 and 2 can vary depending upon the embodiment and the processing power required by the entity. For example, the computers can lack some of the components described above, such as keyboards 910, graphics adapters 912, and displays 918.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method for performing incubation of software platform, the method comprising:
receiving from a code repository, software components for a software platform configured to run on a target cloud platform;
selecting a cloud platform account from an account pool comprising one or more cloud platform accounts having access to cloud platform resources;
identifying a cloud provisioning template for running the software platform;
receiving information describing deployment of the software platform based on the cloud provisioning template;
configuring the cloud platform account to run the software platform, comprising, accessing a set of software artifacts, accessing one or more custom tools, running one or more automated custom scripts, and executing the software platform using the set of software artifacts, one or more custom tools, and one or more automated custom scripts;
bundling the set of software artifacts, one or more custom tools, and one or more automated custom scripts used for running the software platform in a software repository;
creating a software platform package based on the set of software artifacts, one or more custom tools, and one or more automated custom scripts used for running the software platform included in the software repository; and
providing the software platform package to a second cloud platform account associated with a tenant of the target cloud platform for deployment and execution of the software platform for the tenant.

2. The method of claim 1, wherein the set of software artifacts comprises one or more external vendor specific software artifacts.

3. The method of claim 1, wherein accessing the set of software artifacts comprises:
identifying a particular software artifact;
finding one or more other software artifacts on which the particular software artifact depends; and
including the one or more other software artifacts in the set of software artifacts.

4. The method of claim 1, wherein bundling the set of software artifacts comprises:
receiving a trigger based on a code repository; and
responsive to the trigger, filling out a template that describes an environment used for executing the software platform.

5. The method of claim 4, wherein the software platform package is determined based on deployment states of an application environment, the deployment states describing components comprising one or more of: networking, storage, share services, data, software, and application specific components.

6. The method of claim 1, wherein bundling the set of software artifacts is based on one or more regulatory guidelines.

7. The method of claim 6, wherein a regulatory guideline requires detection of data privacy classification.

8. The method of claim 6, wherein a regulatory guideline requires scanning a database for personally identifiable information.

9. The method of claim 8, wherein bundling the set of software artifacts is aborted responsive to detecting personally identifiable information in the database.

10. The method of claim 1, wherein the software platform comprises one or more components including: software artifacts, infrastructure, network components, configuration, or database.

11. A non-transitory computer-readable storage medium storing instructions that are executable by a one or more computer processors, the instructions causing the one or more computer processors to perform steps comprising:
receiving from a code repository, software components for a software platform configured to run on a target cloud platform;
selecting a cloud platform account from an account pool comprising one or more cloud platform accounts having access to cloud platform resources;
identifying a cloud provisioning template for running the software platform;
receiving information describing deployment of the software platform based on the cloud provisioning template;
configuring the cloud platform account to run the software platform, comprising, accessing a set of software artifacts, accessing one or more custom tools, running one or more automated custom scripts, and executing the software platform using the set of software artifacts, one or more custom tools, and one or more automated custom scripts;
bundling the set of software artifacts, one or more custom tools, and one or more automated custom scripts used for running the software platform in a software repository;
creating a software platform package based on the set of software artifacts, one or more custom tools, and one or more automated custom scripts used for running the software platform included in the software repository; and
providing the software platform package to a second cloud platform account associated with a tenant of the target cloud platform for deployment and execution of the software platform for the tenant.

12. The non-transitory computer-readable storage medium of claim 11, wherein the set of software artifacts comprises one or more external vendor specific software artifacts.

13. The non-transitory computer-readable storage medium of claim 11, wherein accessing the set of software artifacts comprises:
identifying a particular software artifact;
finding one or more other software artifacts on which the particular software artifact depends; and
including the one or more other software artifacts in the set of software artifacts.

14. The non-transitory computer-readable storage medium of claim 11, wherein bundling the set of software artifacts comprises:
receiving a trigger based on a code repository; and
responsive to the trigger, filling out a template that describes an environment used for executing the software platform.

15. The non-transitory computer-readable storage medium of claim 14, wherein the software platform package is determined based on deployment states of an application environment, the deployment states describing components comprising one or more of: networking, storage, share services, data, software, and application specific components.

16. The non-transitory computer-readable storage medium of claim 11, wherein bundling the set of software artifacts is based on one or more regulatory guidelines.

17. The non-transitory computer-readable storage medium of claim 16, wherein a regulatory guideline requires detection of data privacy classification.

18. The non-transitory computer-readable storage medium of claim 16, wherein a regulatory guideline requires scanning a database for personally identifiable information.

19. The non-transitory computer-readable storage medium of claim 18, wherein bundling the set of software artifacts is aborted responsive to detecting personally identifiable information in the database.

20. A system, comprising:
one or more computer processors; and
a non-transitory computer-readable storage medium storing instructions that are executable by a one or more computer processors, the instructions causing the one or more computer processors to perform steps comprising:
receiving from a code repository, software components for a software platform configured to run on a target cloud platform;
selecting a cloud platform account from an account pool comprising one or more cloud platform accounts having access to cloud platform resources;
identifying a cloud provisioning template for running the software platform;
receiving information describing deployment of the software platform based on the cloud provisioning template;
configuring the cloud platform account to run the software platform, comprising, accessing a set of software artifacts, accessing one or more custom tools, running one or more automated custom scripts, and executing the software platform using the set of software artifacts, one or more custom tools, and one or more automated custom scripts;
bundling the set of software artifacts, one or more custom tools, and one or more automated custom scripts used for running the software platform in a software repository;
creating a software platform package based on the set of software artifacts, one or more custom tools, and one or more automated custom scripts used for running the software platform included in the software repository; and
providing the software platform package to a second cloud platform account associated with a tenant of the target cloud platform for deployment and execution of the software platform for the tenant.
